(19) United States
(12) Patent Application Publication
(10) Pub. No.: US 2009/0259953 A1
(43) Pub. Date: Oct. 15, 2009

(54) Customizable Specification Library

(76) Inventors: Frederick P. Jannott, Green Farms, CT (US); William Jannott, Newtown, CT (US)

Correspondence Address: ST. ONGE STEWARD JOHNSTON & REENS, LLC, 986 BEDFORD STREET, STAMFORD, CT, 06905-5619, US

(21) Appl. No.: 12/423,517

(22) Filed: Apr. 14, 2009

Related U.S. Application Data
(60) Provisional application No. 61/044,555, filed on Apr. 14, 2008.

(51) Int. Cl. G06F 3/00; G06F 15/16

(52) U.S. Cl. 715/762; 709/203

(57) ABSTRACT

A system and method for generating custom construction specifications for use with a graphic user interface. The system provides for a user's own specifications to be uploaded to the system and adapted for use with the system graphic user interface as a custom master specification. Additionally, the system allows for modification of the custom master specification by inclusion of system specification(s) and/or custom specification data to be input into and saved to the custom master specification. The system further provides for versatility in the selected format of the individual project specifications generated by the system.

### CROSS-REFERENCE TO RELATED APPLICATIONS

This application claims the benefit of the filing date of U.S. Patent Application Ser. No. 61/044,555 filed on Apr. 14, 2008.

### FIELD OF THE INVENTION

The invention relates a system for generating construction specifications with a computer, and more specifically to a system and method for generating construction specifications where a user is presented with a series of questions and the responses to those questions are used to generate the construction specifications, where the specifications are fully customizable by the user.

### BACKGROUND OF THE INVENTION

Typically, a construction project includes construction documents that are used by a builder to identify what is to be built and the types of materials that are to be used. In the project design process, construction documents that identify, for example, the types of materials to be used are called construction specifications.

Specifications may at times, comprise hundreds of pages of text including information, installation instructions, warranties and the like relating to the building products that go into a particular building project.

Specification (spec) writers often pull information from a vast array of sources, including for example, manufacturers, distributors and suppliers. Spec writers may even edit and/or write their own custom specifications for particular building products. In fact, spec writers over time, will often build or compile their own master specifications that include products they are very familiar with and specify often. This can be a time-consuming process, but once compiled, can save vast amounts of time going forward. Where projects are fast-moving, reviewing vast amounts of product literature can be challenging for the spec writer. Some systems have attempted to shorten the time for spec writers by providing systems that generate written documents.

For example, U.S. Patent Application Publication No. US 2002/0077939 (“Nicastro”) discloses an item data management system for use in the design and build industry to manage the lifecycles of items used in a project. Specifically, Nicastro provides: a user data entry interface into which a plurality of data values are received, where the plurality of data fields comprise a specification for the item and each data field of the specification describes an attribute of the item. Nicastro further provides for storing the specification into a database on a computer system. In other words, Nicastro allows a user to select various items from a list of stored items for generating a purchase order for the item. A major failing of Nicastro, however, is the lack of customization. For example, Nicastro does not provide for the user to compile their own master specifications the spec writer is familiar with or prefers. Additionally, Nicastro requires that attributes and references must be defined in templates for each type of item specification meaning that the spec writer cannot select the formatting of the written specification but is tied to the purchase order format disclosed in Nicastro. The lack of versatility of the system taught in Nicastro limits its usefulness to the spec writer.

Due to the limitations of current systems, in order to generate a construction specification for a construction project, spec writers often have to use a specification system, such as is disclosed in Nicastro, spending the time to educate themselves on the products available in the database and with the pre-defined format of the system, or hand-edit their custom master specifications they are already familiar with. Both of these options waste time and resources. In fact, many spec writers often will simply take their prior projects specifications and re-edit them from job to job and will continue this process in order to save time. Unfortunately, due to relatively short time constraints and human error, the generated construction specifications produced may be incomplete because some removed sections were not considered for the next project when the user reused prior project specifications rather than their relatively complete custom master specifications.

Therefore, while it is known to provide, for example, a listing of questions to user for generation of a construction specification, none of the existing systems allows for a user to be provided via a Graphic User Interface (GUI), questions relating to their own master specification. Nor do existing systems allow for customization of the format of the specification.

### SUMMARY OF THE INVENTION

Accordingly, what is desired then is a system and method for generating custom construction specification that utilize a user's own master specifications in computer format.

It is further desired to provide a system and method for generating custom construction specifications that reduces the time involved for the user to generate the construction specifications while still maintaining high quality of the final work product.

It is still further desired to provide a system and method for generating custom construction specifications via a web page over computer network connection.

It is yet further desired to provide a system and method for generating custom construction specifications that will provide additional construction specifications information for products not contained in a user's custom master specification.

Finally, it is desired to provide a system and method for generating custom construction specifications that allows the user to select the format of the specifications to be generated.

These and other objects are achieved in one advantageous embodiment by the provision of a web-based application that will import a spec writer's own master specification and convert it to a user interface. A GUI will allow the user to quickly select sections and attributes for a project. This will advantageously allow the user to quickly edit and create a specification for a construction project. The user will consider all possible products and attributes as is presented by the GUI.

A method according to an advantageous embodiment of the present invention may include some or all of the following steps:
1. A user logs into a web-based specification generating system.
2. The user uploads and/or imports their master specification file(s). Alternatively, it is conceived that the user may simply provide information pointing to a location as to where the master specification file(s) is/are located to be accessed by the system.
3. The system reads the file(s), imports the text into a database, and translates the text into a GUI.
   a. The user may also choose to update the text in the specification sections; or
   b. The user may re-upload/import a new version of the master specification, which will recreate the GUI.
4. The user creates a project by filling in data fields describing a particular project.
5. The user selects specification sections and section attributes to configure the particular project construction specifications.
6. The user generates the construction specification for the particular construction project.

In this manner, a construction specification may be quickly and accurately be generated by a user, utilizing the user's own master specifications via a GUI. The user is intimately familiar with the specifications because they substantially comprise his own master specifications, while the GUI will ensure that a thorough and complete construction specification is generated for each project.

Additionally, if the user's master specification is not complete or does not include a description of a particular product to be provided for a project, the user may browse additional specifications from the system related to the product or type of product and edit his master specification for future use such that the additional information may be presented to the user via the GUI.

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The term “network” as used herein includes both networks and internetworks of all kinds, including the Internet, and is not limited to any particular network or inter-network.

The terms “first” and “second” are used to distinguish one element, set, data, object or thing from another, and are not used to designate relative position or arrangement in time.

The terms “coupled”, “coupled to”, and “coupled with” as used herein each mean a relationship between or among two or more devices, apparatus, files, programs, media, components, networks, systems, subsystems, and/or means, constituting any one or more of (a) a connection, whether direct or through one or more other devices, apparatus, files, programs, media, components, networks, systems, subsystems, or means, (b) a communications relationship, whether direct or through one or more other devices, apparatus, files, programs, media, components, networks, systems, subsystems, or means, and/or (c) a functional relationship in which the operation of any one or more devices, apparatus, files, programs, media, components, networks, systems, subsystems, or means depends, in whole or in part, on the operation of any one or more others thereof.

The terms “process” and “processing” as used herein each mean an action or a series of actions including, for example, but not limited to the continuous or non-continuous, synchronous or asynchronous, direction of data, modification, formatting and/or conversion of data, tagging or annotation of data, measurement, comparison and/or review of data, and may or may not comprise a program.

In one advantageous embodiment a method for generating custom specifications with a specification generation system is provided comprising the steps of accessing graphic user interface with a user computer via a network connection, generating a master custom specification and saving the master custom specification. The method further comprises the steps of associating the master custom specification with the graphic user interface and selecting portions of the master custom specification via the graphic user interface. Finally, the method comprises the steps of generating a project specification based on the selected portions of the master custom specification and saving the project specification on a storage device.

In another advantageous embodiment a system for generating custom specifications is provided comprising a server having a network connection, a user computer coupled to the sever via the network connection and a storage device accessible by the server. The system further comprises a graphic user interface accessible by the user computer and a master custom specification generated by the system and saved on the storage device. The system is provided such that the master custom specification is generated based on data input to the system by a user where the master custom specification is customized to the particular user. The system is further provided such that the master custom specification is automatically associated with the graphic user interface where a project specification is generated based on selecting portions of the master custom specification via the graphic user interface.

In still another advantageous embodiment a system for generating custom specifications is provided comprising a server coupled to a network, a user computer coupled to the network and a storage device coupled to the server. The system further comprises a web-based graphic user interface executing on the server and accessible by the user computer and a specification file uploaded to the system, where the specification file comprises text relating to construction specifications. The system still further comprises a master custom specification generated by the system based at least in part on the specification file and saved on the storage device. The system is provided such that the master custom specification is adapted to the graphic user interface such that a user selects portions of the master custom specification via the graphic user interface and a project specification is generated based on selecting portions of the master custom specification via the graphic user interface.

Other objects of the invention and its particular features and advantages will become more apparent from consideration of the following drawings and accompanying detailed description.

### BRIEF DESCRIPTION OF THE DRAWINGS

FIG. 1 is a block diagram on one advantageous embodiment of the present invention.

FIG. 2 is flow diagram illustrating a method of generating a project specification according to the embodiment of FIG. 1.

FIG. 3 is a flow diagram according to FIG. 2.

FIG. 4 is a flow diagram according to FIG. 3.

### DETAILED DESCRIPTION OF THE INVENTION

Referring now to the drawings, wherein like reference numerals designate corresponding structure throughout the views.

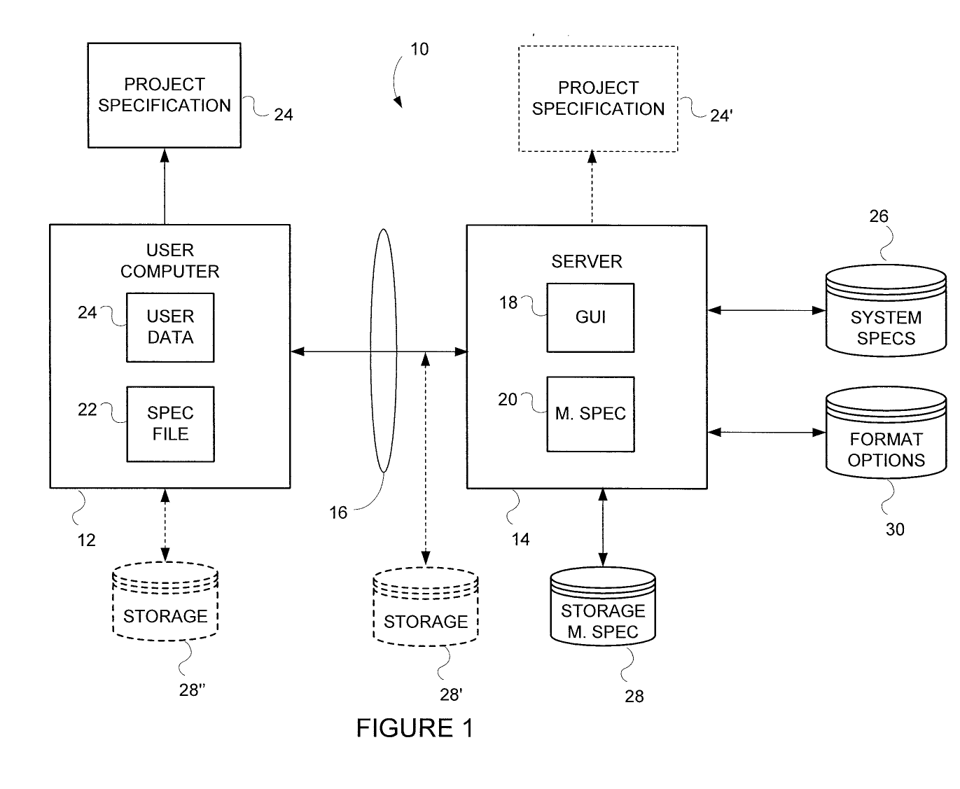

FIG. 1 is a block diagram depicting specification generation system 10, which generally comprises a user computer 12 coupled to a server 14 via a network connection 16. It is contemplated that network connection may comprise, for example, the Internet.

Server 14 is further shown with Graphic User Interface (GUI) 18, which is accessible by user computer 12 and executes on server 14. In this manner, a user (spec writer) may access server 14 via the GUI 18 presented in the format of a web page. Initially, it is contemplated that the user can log onto server 14 by entering a user name and password. Once logged on, the user may be presented with a number of options. If the user has not yet generated a master custom specification 20, the user may be presented with the opportunity to do so. For example, the user may have already generated a specification file 22 that comprises the user's own master specifications they have compiled and/or written over a period of time. If this is the case, the user may upload the specification file 22 to server 14 via the network connection 16. The server 14 receives the specification file 22, which will be in the form of text (the formatting may vary considerably). The system will then adapt the text of the uploaded specification file 22 for use with the graphic user interface 18. In other words, the information contained in the specification file 22 will be accessible to the user via the GUI 18 such that the user will be presented with, for example, a series of questions, the answers to which will determine what text is to be used in generating the project specification 24.

In this manner, a user is able to upload/import their own specifications that they are familiar and comfortable with. The user can then immediately start using the system via the GUI 18 and will not have to meticulously read new specifications information as they will be presented with their own, known specification information. The GUI 18 will present a thorough set of questions to the user based on the generated master custom specification 20 so that a complete specification will be generated for each job.

It is further contemplated that the master custom specification 20 may partly comprise information taken from the user's specification file 22, but may further be built based upon user data 24 input by the user and/or by selection of system specifications 26 selected for inclusion by the user. For example, the user may import their own specification file 22 including much of their own information relating to construction specification information. However, the user's specification file 22 may not include some information relating to a particular item to be specified on a project (e.g. doors). In this event, the user may review system specs 26 to select specifications relating to doors to be saved into the user's master custom specification 20. Alternatively, the user may have other information (user data 24) that they would prefer to enter into the system for saving into the user's master custom specification 20. In this manner, the system 10 is very flexible, allowing the user to use their own information, but allowing for modification and adding of information if so desired.

Once the master custom specification 20 is generated, either by adaptation of specification file 22, selection of system specifications 26, input of user data 24 or any combination thereof, the master custom specification 20 is saved to storage 28. Storage (28, 28′, 28″) are variously shown in dashed lines indicating that the ultimate location of the storage may vary. For example, storage 28 is shown positioned at server 14, but it may very well be located remote from server 14 via the network 16 connection (storage 28′) or may be located at the user computer 12 (storage 28″) where the server knows where to look for the file location. Alternatively, master custom specification 20 may be saved in multiple locations.

Also illustrated in FIG. 1 is format options 30. The user may be provided with the opportunity to generate project specification 24 in many differing formats, such as for example, but not limited to, a page format, a sheet format, a numbered format conforming with Construction Specifications Institute three part format and the like. It is contemplated that a large number of formatting options may be available to the user providing maximum versatility.

Project specifications 24 is variously illustrated as project specifications (24) shown generated by user computer 12 or project specifications (24′) generated by server 14. It is contemplated that the actual project specifications (24, 24′) may be generated by either computer and/or may be printed at the user computer 12 or may be sent to and printed at any remote location as desired. In any event, once generated, the project specifications may be saved in storage (28, 28′, 28″) as desired. Additionally, while system specifications 26 and format options 30 are shown coupled to server 30, it is contemplated that they may be located virtually anywhere and are merely accessible to the user via the GUI 18.

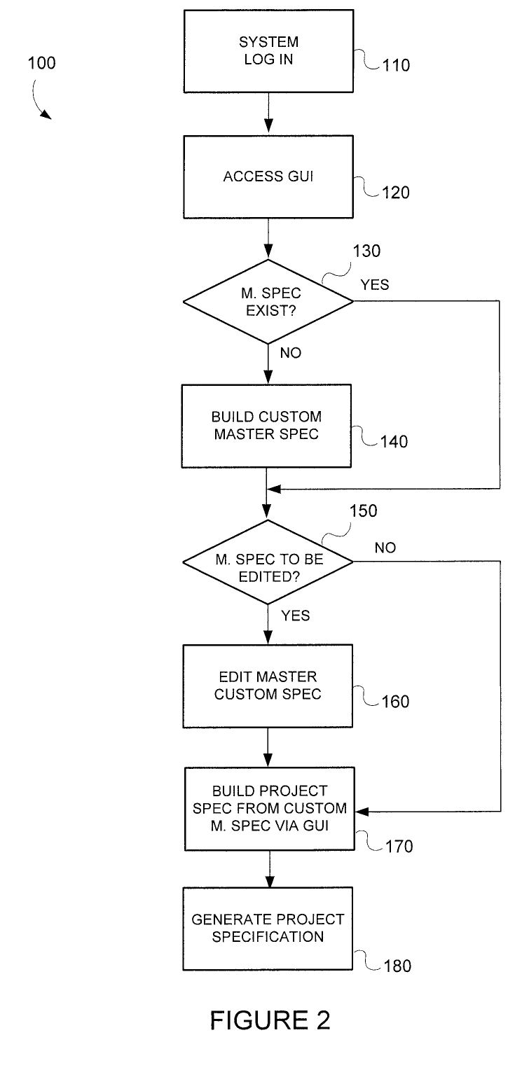

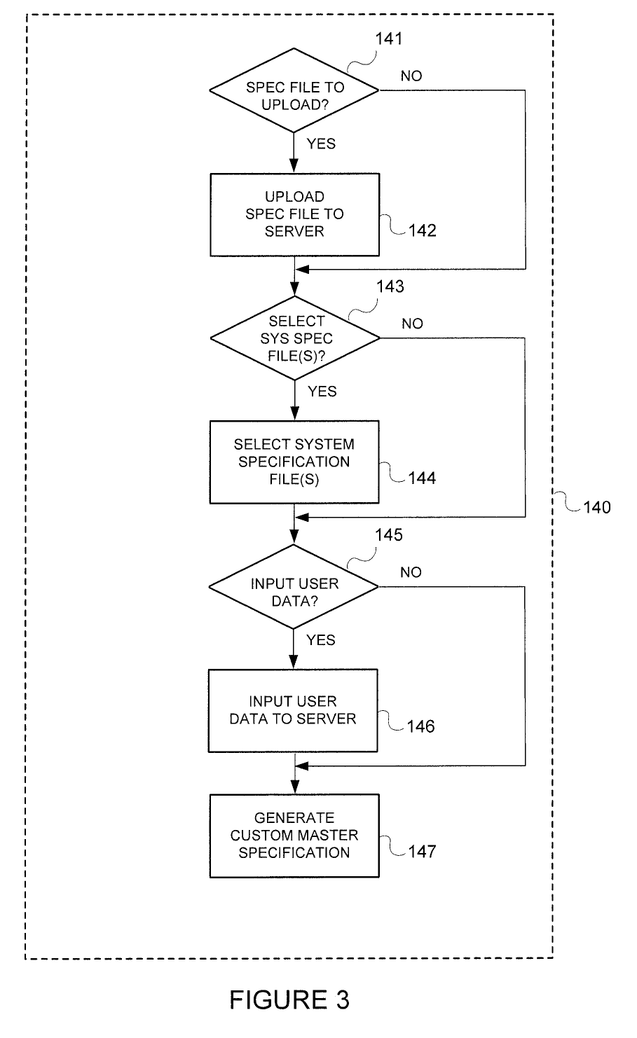

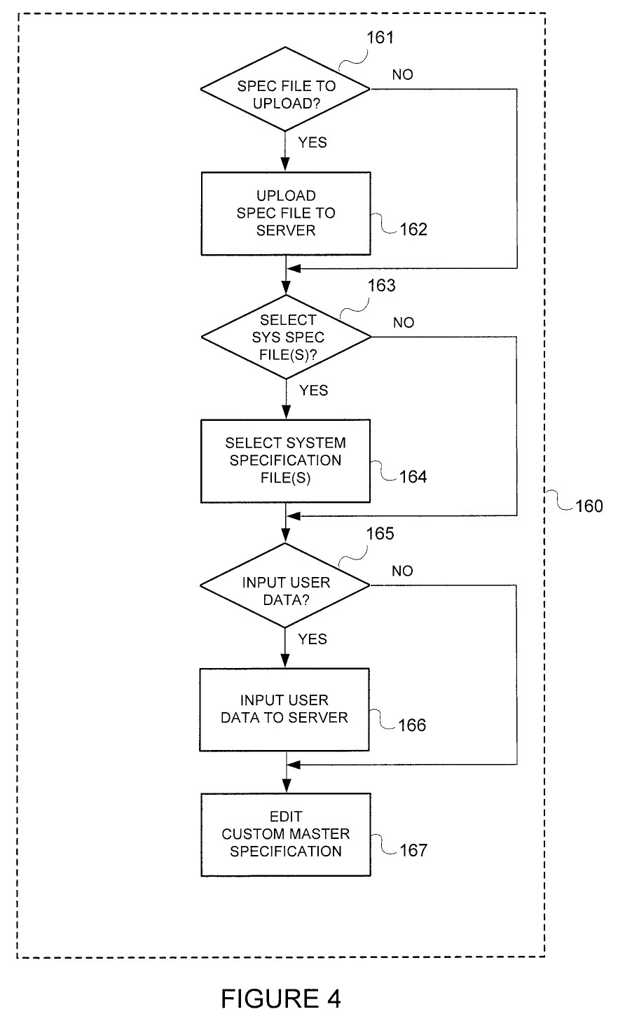

FIG. 2 is a flow diagram illustrating a method 100 for generating custom specifications. Initially, user logs into the system 110 and is then presented with GUI 120. The method may then include the step of determining whether or not a custom master specification exits 130. If not, the system will then guide the user through the process of build a custom master specification 140. This process is shown in greater detail in FIG. 3, which will be discussed below. If a custom master specification is already in existence, the GUI may then prompt the user as to whether the custom master specification is to be edited or modified 150. If so, the system will then guide the user through the process of editing and/or modifying the custom master specification 160. This process is shown in greater detail in FIG. 4, which will be discussed below. If the custom master specification is not to be edited and/or modified, the method then includes the step of building a project specification from the custom master specification via the GUI 170.

Building the project specification is simple as the GUI may present, for example a series of questions or options for the user and based on the user's responses, will select various portions of the custom master specification for inclusion in the particular project specification. In this manner, a complete specification will be generated as the user is not using a specification from a previous job that may or may not comprise a complete specification as saved in the custom master specification.

Referring now to FIG. 3, the process for building a custom master specification 140 is illustrated. For example, the method may include the step of prompting the user to upload a specification file 141 if the user desires. If so, the user may simply upload the user's own specification file 142 that includes construction specification data familiar to the user. The system receives the data (text) and adapts the information for use with the GUI. If no specification file is to be uploaded, the system may prompt the user as to whether system specification files are to be used 143. If so, the user may select various system specification files 144 as desired for inclusion into the custom master specification. If not, the method may further prompt the user as to whether the user has user data 145 (custom spec information) the user would like to upload to the system. If so, the user may then input virtually any data 146 into the GUI desired relating to virtually any type of construction product. Based on the user's input and selections, the system then generates a custom master specification 147 that is usable with the GUI.

Turning now to FIG. 4, the process of editing and/or modifying the custom master specification 160 is illustrated in greater detail. As can be seen, the process of editing and/or modifying the custom master specification 160 is similar to the process for building a custom master specification 140 as illustrated in FIG. 3. For clarity, however, the process will described again below.

The process of editing and/or modifying the custom master specification 160 may include the step of prompting the user to upload a specification file 161 if the user desires. If so, the user may simply upload the user's own specification file 162 that includes construction specification data familiar to the user. In this case, the newly uploaded file may replace all or any portion of the existing custom master specification. The system receives the data (text) and adapts the information for use with the GUI. If no specification file is to be uploaded, the system may prompt the user as to whether system specification files are to be used 163. Again, any portion of or all of the existing custom master specification file may be replaced. If so, the user may select various system specification files 164 as desired for inclusion into the custom master specification. If not, the method may further prompt the user as to whether the user has user data 165 (custom spec information) the user would like to upload to the system. If so, the user may then input virtually any data 166 into the GUI desired relating to virtually any type of construction product. Based on the user's input and selections, the system then generates a revised custom master specification 167 that is usable with the GUI.

It should be noted that, while various functions and methods have been described and presented in a sequence of steps, the sequence has been provided merely as an illustration of one advantageous embodiment, and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions described herein.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A method for generating custom specifications with a specification generation system comprising the steps of:
accessing graphic user interface with a user computer via a network connection;
generating a master custom specification;
saving the master custom specification;
associating the master custom specification with the graphic user interface;
selecting portions of the master custom specification via the graphic user interface;
generating a project specification based on the selected portions of the master custom specification; and
saving the project specification on a storage device.

2. The method according to claim 1 wherein the step of generating the master custom specification includes uploading a specification file to the system.

3. The method according to claim 2 wherein the system adapts text of the uploaded specification file for use with the graphic user interface.

4. The method according to claim 1 wherein the step of generating the master custom specification includes selection of text presented to the user by the graphic user interface.

5. The method according to claim 1 wherein the storage device is located remotely from the user computer.

6. The method according to claim 1 wherein the master custom specification is saved into a database accessible by the system.

7. The method according to claim 6 further comprising the step of subsequently altering the master custom specification.

8. The method according to claim 6 further comprising the step of subsequently replacing the master custom specification.

9. The method according to claim 1 further comprising the step of selecting a format for the project specification.

10. The method according to claim 1 wherein the user accesses the graphic user interface by logging into the specification generation system.

11. The method according to claim 1 wherein the graphic user interface is a web-based application.

12. The method according to claim 1 wherein the network comprises the Internet.

13. The method according to claim 12 wherein the user computer couples to a server via the Internet to access the graphic user interface.

14. A system for generating custom specifications, the system comprising:
a server having a network connection;
a user computer coupled to said sever via the network connection;
a storage device accessible by said server;
a graphic user interface accessible by said user computer; and
a master custom specification generated by the system and saved on said storage device;
said master custom specification generated based on user data input to the system by a user such that said master custom specification is customized to the particular user;
said master custom specification automatically associated with said graphic user interface such that a project specification is generated based on selecting portions of the master custom specification via the graphic user interface.

15. The system according to claim 14 further comprising a specification file uploaded to the system, wherein said master custom specification is generated at least in part from said specification file.

16. The system according to claim 15 wherein the system adapts text of the uploaded specification file for use with said graphic user interface.

17. The system according to claim 14 wherein said master custom specification is generated at least in part, by the selection of text presented to the user by the graphic user interface

18. The system according to claim 14 wherein said storage device is located remotely from said user computer.

19. The system according to claim 14 wherein said master custom specification is saved into a database accessible by the system.

20. The system according to claim 19 wherein said master custom specification is subsequently altered and the altered master custom specification is saved into the database.

21. The system according to claim 14 wherein a format for the project specification is selectable.

22. The system according to claim 14 wherein said graphic user interface comprises a web-based application.

23. The system according to claim 14 wherein the network comprises the Internet.

24. A system for generating custom specifications, the system comprising:
a server coupled to a network;
a user computer coupled to the network;
a storage device coupled to said server;
a web-based graphic user interface executing on said server and accessible by said user computer;
a specification file uploaded to said system, said specification file comprising text relating to construction specifications;
a master custom specification generated by the system based at least in part on said specification file and saved on said storage device;
wherein said master custom specification is adapted to said graphic user interface such that a user selects portions of said master custom specification via said graphic user interface; and
wherein a project specification is generated based on selecting portions of the master custom specification via the graphic user interface.

25. The system according to claim 24 wherein the network comprises the Internet.

26. The system according to claim 24 wherein said master custom specification is generated based on both said uploaded specification file and system specifications presented to and selected by the user via said graphic user interface.

27. The system according to claim 24 wherein said master custom specification is updateable.

28. The system according to claim 24 wherein a format for the project specification is selectable.
